(19) United States
(12) Patent Application Publication
(10) Pub. No.: US 2005/0280608 A1
(43) Pub. Date: Dec. 22, 2005

(54) Driving method of plasma display panel

(76) Inventors: Gab-Sick Kim, Suwon-si (KR); Yoon-Hyoung Cho, Suwon-si (KR)

Correspondence Address: CHRISTIE, PARKER & HALE, LLP, PO BOX 7068, PASADENA, CA, 91109-7068, US

(21) Appl. No.: 11/137,202

(22) Filed: May 24, 2005

(30) Foreign Application Priority Data
Jun. 18, 2004 (KR) 10-2004-0045471

(51) Int. Cl. G09G 3/28

(52) U.S. Cl. 345/63

(57) ABSTRACT

In a plasma display panel, a plurality of row electrodes is divided into a plurality of row groups. One row group is driven by a first method and the remaining row groups are driven by a second method. Light-emitting cells are set by a selective write process in a first subfield and by a selective erase process in the remaining subfields. When the selective write process and the selective erase process are simultaneously in one address period, the selective erase process is first performed. In addition, when selective erase processes for the plurality of row groups are simultaneously performed in one address period, a scan pulse of a selective erase process first performed has a smaller width.

### CROSS REFERENCE TO RELATED APPLICATION

This application claims priority to and the benefit of Korean Patent Application No. 10-2004-0045471 filed on Jun. 18, 2004 in the Korean Intellectual Property Office, the entire content of which is incorporated herein by reference.

### BACKGROUND OF THE INVENTION

1. Field of the Invention

The present invention relates to a driving method of a plasma display panel.

2. Description of the Related Art

Plasma displays are displays using plasma display panels (PDPs) that use plasma generated by gas discharge to display characters or images. The PDPs include, according to their size, more than several hundreds of thousands to millions of discharge cells (i.e., pixels) arranged in the form of a matrix. That is, the discharge cells are formed in spaces defined by a plurality of row electrodes, each of which generally consists of a pair of a scan electrode and a sustain electrode, and a plurality of column electrodes.

Generally, in a PDP, one field (1TV field) is divided into a plurality of subfields each having its own weight. Gray scales are represented by combinations of weights of active (i.e., displayed) ones of the plurality of subfields. Each subfield includes an address period, during which lighting ones of discharge cells are selected, and a sustain period, during which the discharge cells selected during the address period are sustained and discharged for a period corresponding to its weight.

There is a method of performing a sustain discharge operation for all discharge cells after completing an addressing operation for all discharge cells in each subfield, that is, temporarily separating the address period from the sustain period, which is generally called an address display period separation (ADS) method in the art. This ADS method can be easily implemented, but since the addressing operation is sequentially performed for all discharge cells, some discharge cells to be later addressed may not be addressed due to lack of priming particles within the discharge cells. Therefore, in order to secure a stable address discharge, it is necessary to increase the width of scan pulses sequentially applied to row electrodes, and hence increase the length of the address period. As a result, the length of subfields also becomes long, limiting the number of subfields available in one field.

Unlike the ADS method, there is an alternative method of inserting an address pulse of each line between two successive sustain discharge pulses and performing the addressing operation for one line while performing the sustain discharge operation for another line, that is, a method wherein the address period is not separated from the sustain period, which is generally called an address while display (AWD) method.

As an example of the AWD method, U.S. Pat. No. 6,495,968 issued to Tokunaga discloses a method of forming wall discharges in each discharge cell by sequentially resetting a plurality of row electrodes, and then, sequentially erasing the wall discharges from non-light-emitting discharge cells. With the method of Tokunaga, although a high-speed scan can be achieved, for example, a reset of an i^{th} row electrode must be performed while sustain discharge pulses are applied to the remaining row electrodes. For example, if the number of row electrodes is 480, since at least 480 cycles of the sustain discharge pulses are required to reset all row electrodes, the maximum time assignable for the reset operation is 34.7 μs (=16.67 ms/480).

However, if the reset operation is performed with a strong discharge, a dark screen may become bright due to light generated by the strong reset discharge, that is, a contrast becomes deteriorated. Accordingly, the reset operation is required to be performed with a weak discharge, however, the time of 34.7 μs is too short to perform the reset operation with the weak discharge.

### SUMMARY OF THE INVENTION

In the present invention, a driving method for a plasma display panel is provided, which is capable of performing a high-speed scan operation as well as improving a contrast ratio.

According to one aspect, the present invention provides a driving method of dividing one field into a plurality of subfields and representing gray scales using the plurality of subfields in a plasma display panel including a plurality of row electrodes for performing a display operation, the plurality of row electrodes being grouped into a plurality of row groups, a plurality of column electrodes intersecting the plurality of row electrodes, and a plurality of discharge cells defined by the plurality of row electrodes and the plurality of column electrodes.

In an exemplary embodiment of the present invention, in at least one subfield, an address period during which light-emitting cells of discharge cells of a first row group are selected is performed, and a sustain period during which light-emitting cells of discharge cells of the plurality of row groups are sustain-discharged is performed. In addition, an address period during which light-emitting cells of discharge cells of a second row group are selected is performed, and the sustain period during which light-emitting cells of discharge cells of the plurality of row groups are sustain-discharged is performed. In addition, the plurality of subfields includes a first group of subfields including a first subfield positioned at the head in time of the plurality of subfields and a second group of subfields. The light-emitting cells are selected by write-discharging non-light-emitting cells in a first address period which is the address period for the first group of subfields, and the non-light-emitting cells are set by erase-discharging the light-emitting cells in a second address period which is the address period for the second group of subfields.

In another exemplary embodiment of the present invention, discharge cells in a first subfield of the plurality of subfields are initialized. Light-emitting cells are sequentially set for each row group in the first subfield by a first type address discharge, and the light-emitting cells are sustain-discharged between steps of setting light-emitting cells for two adjacent row groups in the first subfield. Light-emitting cells are sequentially set for each row group in a second subfield of the plurality of subfields by a second type address discharge, and the light-emitting cells are sustain-discharged between steps of setting light-emitting cells for two adjacent row groups in the second subfield. In addition, light-emitting cells of the second subfield for a second row group are set in a first period between two steps of sustain-discharging immediately before and after the step of setting the light-emitting cells of the first subfield for the first row group.

### BRIEF DESCRIPTION OF THE DRAWINGS

The accompanying drawings illustrate exemplary embodiments of the present invention, and, together with the description, serve to explain the principles of the invention, wherein:

FIG. 1 shows a schematic conceptual diagram of a plasma display according to an exemplary embodiment of the present invention;

FIG. 2 shows a diagram illustrating a driving method for a plasma display panel according to an exemplary embodiment of the present invention;

FIG. 3 shows a diagram illustrating a gray scale representation in the driving method of FIG. 2;

FIG. 4 shows a driving waveform diagram of the plasma display panel according to an exemplary embodiment of the present invention;

FIGS. 5A and 5B show an example of a subfield arrangement according to an exemplary embodiment of the present invention;

FIG. 6 is a graph showing total weights according to a sequence of subfield in the sequence arrangement of FIGS. 5A and 5B.

### DETAILED DESCRIPTION

In the following detailed description, only certain exemplary embodiments of the present invention are shown and described, by way of illustration. As those skilled in the art would recognize, the described exemplary embodiments may be modified in various ways, all without departing from the spirit or scope of the present invention. Accordingly, the drawings and description are to be regarded as illustrative in nature, rather than restrictive. There may be parts shown in the drawings, or parts not shown in the drawings, that are not discussed in the specification as they are not essential to a complete understanding of the invention. Like reference numerals designate like elements.

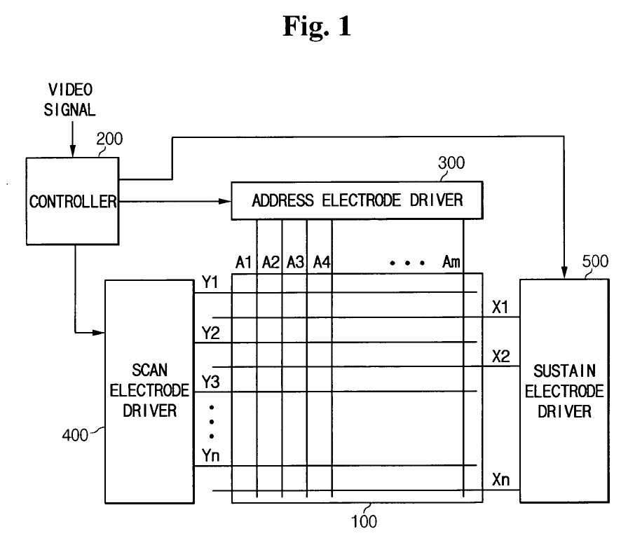

FIG. 1 shows a schematic conceptual diagram of a plasma display according to an exemplary embodiment of the present invention.

As shown in FIG. 1, a plasma display according to the exemplary embodiment of the present invention includes a plasma display panel 100, a controller 200, an address electrode driver 300, a scan electrode driver 400, and sustain electrode driver 500.

The plasma display panel 100 includes a plurality of address electrodes (hereinafter, referred to as “A electrodes”) A1 to Am extending in a column direction, and a plurality of sustain electrodes (hereinafter, referred to as “X electrodes”) X1 to Xn and a plurality of scan electrodes (hereinafter, referred to as “Y electrodes”) Y1 to Yn, which are paired. Generally, the X electrodes X1 to Xn are formed corresponding to the Y electrodes Y1 to Yn. In addition, the plasma display panel 100 includes a substrate (not shown) on which the X and Y electrodes X1 to Xn and Y1 and Yn are formed and a substrate (not shown) on which the A electrodes A1 to Am are formed. The two substrates are arranged opposite to each other with a discharge space provided therebetween in such a manner that the A electrodes A1 to Am are perpendicular to the Y electrodes Y1 to Yn and the X electrodes X1 to Xn. Here, discharge spaces at intersections of the A electrodes A1 to Am and the X and Y electrodes X1 to Xn and Y1 to Yn form discharge cells. The present invention is additionally applicable to plasma display panels having other structures to which driving waveforms, which will be described below, are applied.

In the following description, one discharge cell is defined by a pair of X and Y electrodes and one A electrode. In addition, the pair of X and Y electrodes extending in the row direction is referred to as row electrodes and the A electrode extending in the column direction is referred to as a column electrode.

The controller 200 receives a video signal from the outside and outputs an address driving control signal, a sustain electrode driving control signal, and a scan electrode control signal. In addition, the controller 200 divides one field into a plurality of subfields each having its own weight and drives them. The address electrode driver 300, the X electrode driver 400 and the Y electrode driver 500 apply driving voltages to the A electrodes A1 to Am, the X electrodes X1 to Xn and the Y electrodes Y1 to Yn, respectively.

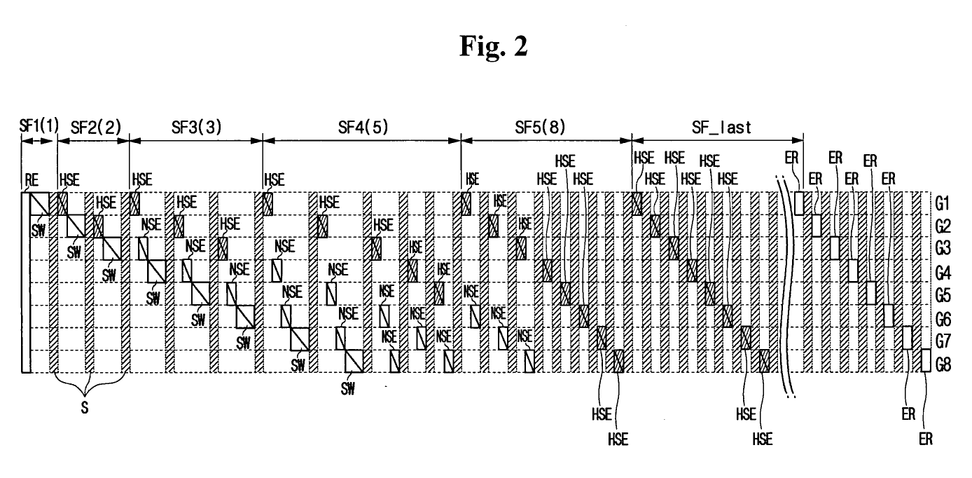

Next, a driving method of the plasma display panel according to an exemplary embodiment of the present invention will be described with reference to FIGS. 2 to 4. In the embodiment of the present invention, it is assumed that the length of sustain periods following address periods of each row group are equal and these sustain periods have the same length in all subfields.

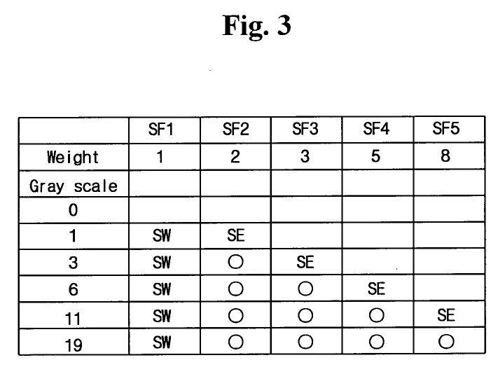

FIG. 2 shows a diagram illustrating a driving method for a plasma display panel according to an exemplary embodiment of the present invention, and FIG. 3 shows a diagram illustrating a gray scale representation in the driving method of FIG. 2.

As shown in FIG. 2, it is assumed that one field is divided into a plurality of subfields SF1 to SF_last and a temporal arrangement of the subfields SF1 to SF_last is in the form of increase in weight. In addition, it is assumed that a plurality of row electrodes X1 to Xn and Y1 to Yn are divided into a plurality of row groups, for example, eight groups in FIG. 2 for the purpose of convenience of explanation. In addition, for the plurality of row groups G1 to G8, the first to j^{th} row electrodes (where, j=n/8) are set as a first row group G1, (j+1)^{th} to (2j)^{th} row electrodes are set as a second row group G2, and, in this way, (7j+1)^{th} to n^{th} row electrodes are set as an eighth row group G8.

Only the first to fifth and last subfields SF1 to SF5 and SF_last are shown in FIG. 2. In this embodiment of the present invention, the subfields are set for each row group. In FIG. 2, the subfields included in the first row group G1 are denoted by reference numerals SF1, SF2, SF3, SF4, SF5 and SF_last. In addition, it is assumed that weights of the first to fifth subfields SF1 to SF5 are 1, 2, 3, 5 and 8, respectively. Further, each subfield represents brightness corresponding to a weight of the subfield when the sustain period S representing brightness corresponding to a weight of 1 is repeated by the number of times corresponding to the weight of the subfield.

The subfield includes an address period during which discharge cells to be light-emitted and discharge cells not to be light-emitted for each subfield are selected from a plurality of discharge cells formed in the plasma display panel 100 and a sustain period during which a sustain discharge operation, i.e., a display operation, is performed during a period corresponding to a weight of a subfield in a discharge cell selected during the address period. Here, the sustain discharge operation is performed when the sum of a wall voltage set between the X electrode and the Y electrode in the address period and a voltage applied between the X electrode and the Y electrode in the sustain period exceeds a discharge start voltage, and the voltage applied in the sustain period is set to a voltage lower than the discharge start voltage.

Processes of selecting the light-emitting discharge cells and the non-light-emitting cells in the address period include a selective write process SW and a selective erase process HSE or NSE. The selective write process is a process for selecting the light-emitting discharge cell and forming a wall voltage on the selected light-emitting discharge cell, and the selective erase process is a process for selecting the non-light-emitting discharge cells and erasing a wall voltage, which has already been formed on the non-light-emitting discharge cell. A state where the light-emitting discharge cell is selected in the address period by the selective write process or the selective erase process is referred to as “a light-emitting cell state”, and a state where the non-light-emitting discharge cell is selected in the address period by the selective write process or the selective erase process is referred to as “a non-light-emitting cell state.”

In this embodiment of the present invention, in an address period of the first subfield SF1 positioned at the head, or first place, in time, discharge cells in the non-light-emitting state are set to the light-emitting cell state by write-discharging the discharge cells to form wall charges on the discharge cells, that is, the selective write process is performed. In address periods HSE or NSE of the remaining subfields SF2 to SF_last, discharge cells in the light-emitting state are set to the non-light-emitting cell state by erase-discharging the discharge cell to erase wall charges from the discharge cells, that is, the selective erase process is performed.

Next, a driving method according to an embodiment of the present invention will be described in detail with reference to FIG. 2.

First, all discharge cells are initialized in order to prevent discharge cells not selected in the first subfield SF1 from being erroneously discharged in the sustain period. Then, a selective write process is performed for discharge cells to be lighted in the address period. Accordingly, the first subfield SF1 has a common reset period RE during which the discharge cells of all row groups G1 to G8 are initialized to be set to the non-light-emitting cell state. At this time, since the reset period RE is performed in common for all discharge cells, and thus, has a sufficient length of period, a reset period during which a weak discharge may occur can be used. Such a reset discharge is known to be performed by using waveforms in which a voltage between electrodes is gradually changed (increased or decreased).

Light-emitting cells of discharge cells in the i^{th} row group Gi (where i is an integer between 1 and 8) are selected through the write discharge in the address period SW of the first subfield SF1 for the i^{th} row group Gi, and the sustain discharge is performed for the light-emitting cells in the sustain period S. Next, non-light-emitting cells of the discharge cells in the i^{th} row group Gi are selected through the erase discharge in the address period HSE or NSE of the second subfield SF2, and the sustain period S during which the sustain discharge is performed for the light-emitting cells is performed twice. Subsequently, the non-light-emitting cells of the discharge cells in the i^{th} row group Gi are selected through the erase discharge in the address period HSE or NSE of the third subfield SF3, and the sustain period S during which the sustain discharge is performed for the light-emitting cells is performed three times. In this way, non-light-emitting cells of the discharge cells in the i^{th} row group Gi are selected in the address period HSE or NSE of each subfield, and the sustain period S during which the sustain discharge is performed for the light-emitting cells for the number of times corresponding to the weight of each subfield. In the last subfield SF_last, an erase period ER is performed during which all discharge cells in the light-emitting cell state in the i^{th} row group Gi are set to the non-light-emitting cell state.

The sustain discharge is performed for the discharge cells selected as the light-emitting cells through the write discharge in the first subfield SF1 before the selected discharge cells are selected as the non-light-emitting cells through the erase discharge in the subsequent subfields, representing a gray scale corresponding to the sum of weights of subfields immediately before a subfield at which the discharge cells are selected as the non-light-emitting cells.

When the second subfield SF2 is performed for the i^{th} row group Gi after the first subfield SF1 is performed for the i^{th} row group Gi, the first subfield SF1 is performed for an (i+1) ^{th} row group Gi+1. This way, the sustain period S is performed for the (i+1) ^{th} row group Gi+1, with one time delay of the sustain period with regard to the i^{th} row group Gi. More specifically, when a q^{th} sustain period S of a k^{th} subfield SFk having a weight of p is performed for the i^{th} row group Gi, a (q−1) ^{th} sustain period S of the k^{th} subfield SFk is performed for the (i+1) ^{th} row group Gi+1 (where, q is an integer between 2 and p). Also, when a first sustain period S of the k^{th} subfield SFk is performed for the i^{th} row group Gi, the last sustain period S of a (k−1) ^{th} subfield SFk-1 is performed for the (i+1) ^{th} row group Gi+1.

In addition, if the first sustain period S of the k^{th} subfield SFk is performed for the i^{th} row group Gi while the first sustain period S of a r^{th} (where, r is a natural number other than k) subfield is performed for other row groups, an address period of the r^{th} subfield along with an address period of the k^{th} subfield SFk are then performed for the i^{th} row group Gi. If the address period of the k^{th} subfield SFk and address periods of a plurality of subfields are simultaneously performed, the address period HSE or NSE of the selective erase process is first performed, and the address period SW of the selective write process is then performed.

At this time, since the address period HSE of the selective erase process, which is first performed, of the plurality of subfields is performed immediately after a sustain period of a just previous subfield, priming particles generated through the sustain discharge in the sustain period of the just previous subfield can be used for the erase discharge. In addition, since wall charges can be erased in the erase discharge through a discharge without a need to accumulate the wall discharges on the discharge cells, a scan pulse applied in the address period of the selective erase process has only to have a width small enough, i.e., about 0.5 μs, that the wall charges can be erased through the discharge. Since a discharge cell in which many priming particles are generated has a short discharge delay time, the width of the scan pulse may be further shortened as compared to when there is no priming particle. Accordingly, when address periods of the plurality of subfields are performed between two adjacent sustain periods, the address period HSE performed first may have a width smaller than that of the address period NSE to be subsequently performed.

Now, the driving method according to this embodiment of the present invention will be again described in more detail with reference to FIG. 2. First, the address period SW and the sustain period S of the first subfield SF1 for the first row group G1 are performed. Subsequently, the address period HSE of the second subfield SF2 for the first row group G1 is performed, the address period SW of the first subfield SF1 for the second row group G2 is performed, and then, the sustain period S is performed.

Next, the address period HSE of the second subfield SF2 for the second row group G2 and the address period SW of the first subfield SF1 for the third row group G3 are successively performed, and then, the sustain period S is performed. Next, the address period HSE of the third subfield SF3 for the first row group G1, the address period NSE of the second subfield SF2 for the third row group G3, and the address period SW of the first subfield SF1 for the fourth row group G4 are successively performed, and then, the sustain period S is performed.

In this way, address periods and sustain periods of all subfields for all row group G1 to G8 may be sequentially performed. In addition, after the sustain period S of the last subfield for each row group is performed for the number of times corresponding to the weight of the last subfield SF_last, the erase period ER for each row group is performed.

Next, a method of representing gray scales using the driving method of FIG. 2 will be described with reference to FIG. 3. In FIG. 3, “SW” represents that a discharge cell is set to the light-emitting cell state through the write discharge occurring in a corresponding subfield, and “SE” represents that a discharge cell is set to the non-light-emitting cell state through the erase discharge occurring in a corresponding subfield. Also, “o” represents the light-emitting cell state in a corresponding subfield. Now, in FIG. 3, a discharge cell of the first row group G1 in FIG. 2 will be described by way of an example.

First, when the non-light-emitting cell state is set in the address period SW of the first subfield SF1, a 0 level of gray scale is represented since the sustain discharge does not occur in the sustain period, and the sustain discharge also does not occur in the subsequent subfields SF2 to SF_last.

In addition, when the light-emitting cell state is set through the write discharge occurring in the address period SW of the first subfield SF1, a 1 level of gray scale can be represented as the sustain discharge occurs in the display period of the subfield SF1. Next, when the non-light-emitting cell state is set through the erase discharge occurring in the address period HSE of the second subfield SF2, only a 1 level of gray scale is represented as the sustain discharge does not occur in the second subfield SF2 and the subsequent subfields. In addition, since the light-emitting cell state remains if the erase discharge does not occur in the second subfield SF2, a 3 (=1+2) level of gray scale is represented as the sustain discharge also occurs in two sustain periods S of the second subfield SF2.

In this way, since the discharge cells set to the light-emitting cell state through the write discharge occurring in the first subfield SF1 and then set to the non-light-emitting cell state through the erase discharge in the i^{th} subfield SFi are sustain-discharged in the first to (i−1) ^{th} subfields SF1 to SFi−1, a gray scale corresponding to the sum of weights of the first to (i−1) ^{th} subfields SF1 to SFi−1 is represented.

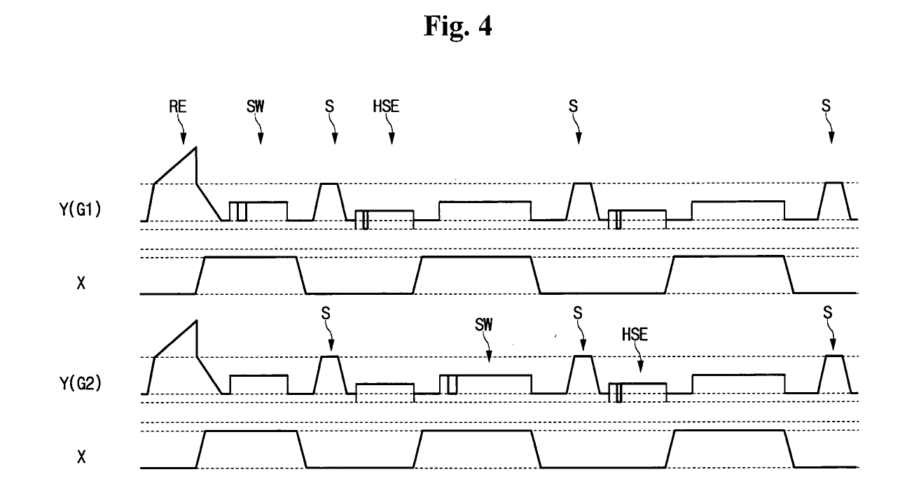

Next, driving waveforms for use with the driving method of the plasma display panel according to an embodiment of the present invention will be described in detail with reference to FIG. 4.

FIG. 4 shows a driving waveform diagram of the plasma display panel according to an embodiment of the present invention. In FIG. 4, for the purpose of convenience of explanation, only the first and second row groups G1 and G2 and the first and second subfields SF1 and SF2 are partially shown, and illustration of the A electrode is omitted. In addition, since the driving waveform shown in FIG. 4 is a driving waveform generally used for the plasma display panel, detailed explanation thereof will be omitted.

As shown in FIG. 4, first, wall charges are formed in the discharge cells by causing the reset discharge. The reset discharge is brought about by gradually increasing a voltage of the Y electrode of both row groups G1 and G2 in the reset period RE of the first subfield SF1 under a state where the X electrode is biased to a ground voltage. Next, the discharge cells are initialized such that addressing of the selective write process can be performed by erasing the wall charges formed by the reset discharge by gradually decreasing the voltage of the Y electrode of the row groups G1 and G2 under a state where the X electrode is biased to a positive voltage.

Subsequently, under the state where the X electrode is biased to the positive voltage, a scan pulse (the ground voltage in FIG. 4) is sequentially applied to the plurality of Y electrodes of the first row group G1, and, although not shown, a positive address voltage is applied to the A electrode of discharge cells to be lighted among the discharge cells formed by the Y electrode to which the scan pulse is applied. Then, the write discharge occurs in the discharge cells to which the scan pulse and the address voltage are applied, thereby setting the discharge cells to the light-emitting cell state by forming wall charges in the X electrode and the Y electrode. At this time, the scan pulse is not applied to the Y electrode of the second row group G2. Subsequently, a sustain discharge pulse is applied to the Y electrode in order to discharge the discharge cells of the light-emitting cell state.

Next, a scan pulse having a negative voltage is sequentially applied to the Y electrode of the first row group G1 in the address period HSE of the second subfield SF2, and then, a positive voltage (not shown) is applied to the A electrode of discharge cells to be set to the non-light-emitting cell state. At this time, the width of the scan pulse is so narrow that wall charges are not formed but erased by discharging. When the negative voltage and the positive voltage are respectively applied to the Y electrode and A electrode of the discharge cells of the light-emitting cell state having the wall voltage formed by the sustain discharge pulse applied to the Y electrode, the wall charges are erased through discharge occurring due to the wall voltage and the applied voltages, which results in the non-light-emitting cell state.

Subsequently, the address period SW of the first subfield SF1 for the second row group G2 is performed. More specifically, under the state where the X electrode is biased to the positive voltage, the scan pulse is sequentially applied to the Y electrode of the second row group G2, and, although not shown, the positive address voltage is applied to the A electrode of discharge cells to be lighted of the discharge cells formed by the Y electrode to which the scan pulse is applied in order to set the discharge cells to be lighted to the light-emitting cell state. Then, the sustain discharge occurs in the light-emitting cells of the first row group G1 by the positive voltage applied to the X electrode and the ground voltage applied to the Y electrode. Subsequently, as the sustain discharge pulse is applied to the Y electrode, the sustain discharge occurs in the light-emitting cells of the first and second row groups G1 and G2.

Next, the address period HSE of the second subfield SF2 for the second row group G2 is performed, and then, although not shown, the address period SW of the first subfield SF1 for the third row group G3 is performed. At this time, the sustain discharge occurs in the light-emitting cells of the first and second row groups G1 and G2 by the positive voltage applied to the X electrode and the ground voltage applied to the Y electrode. Subsequently, as the sustain discharge pulse is applied to the Y electrode, the sustain discharge occurs in the light-emitting cells of the first to third row groups G1 to G3.

In this manner, in the embodiment of the present invention, since the address period of the selective erase process in which the wall charges are not formed are performed in subfields after the first subfield SF1, the width of the scan pulse applied to the Y electrode in the address period can be shorter than the address period of the selective write process. In addition, since priming particles formed by the sustain discharge can be utilized in the addressing operation of the selective erase process performed immediately after the sustain period, a high-speed scan with the scan pulse having a narrower width can be achieved. In addition, since gradually increasing and decreasing voltages are used in the reset period, a strong discharge does not occur in the reset period. In addition, since the reset period is one time performed for all row groups during one field, the contrast ratio can be increased. In addition, in this embodiment of the present invention, there occurs no false contour since the gray scales are represented by the sum of weights of the successive subfields starting from the first subfield.

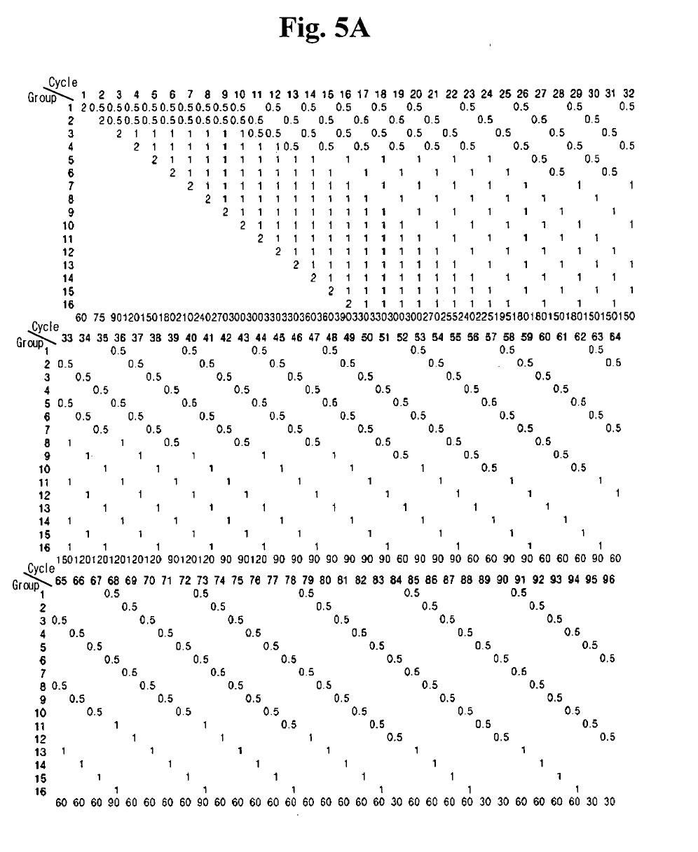

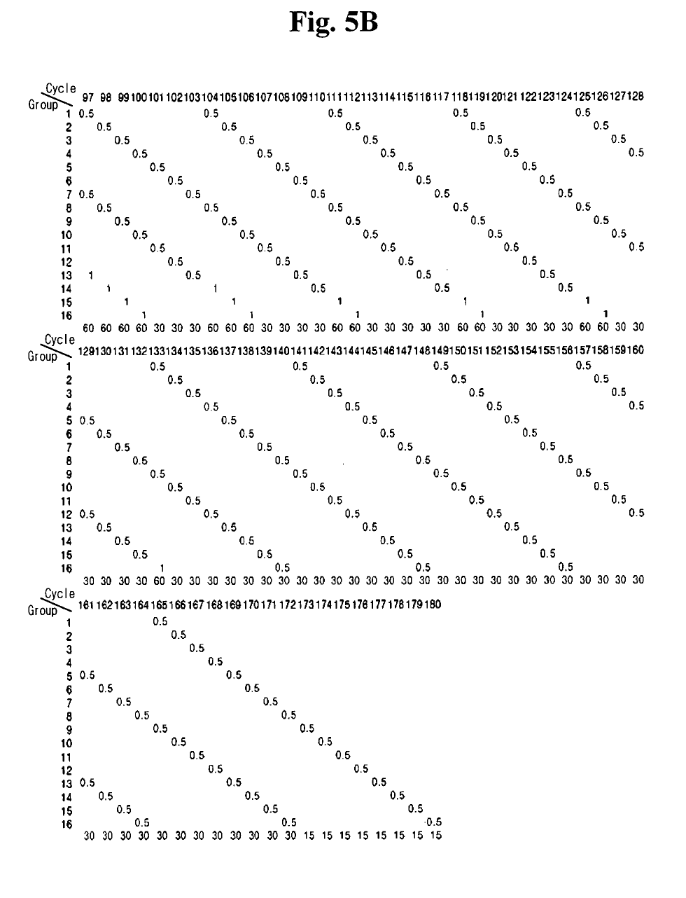

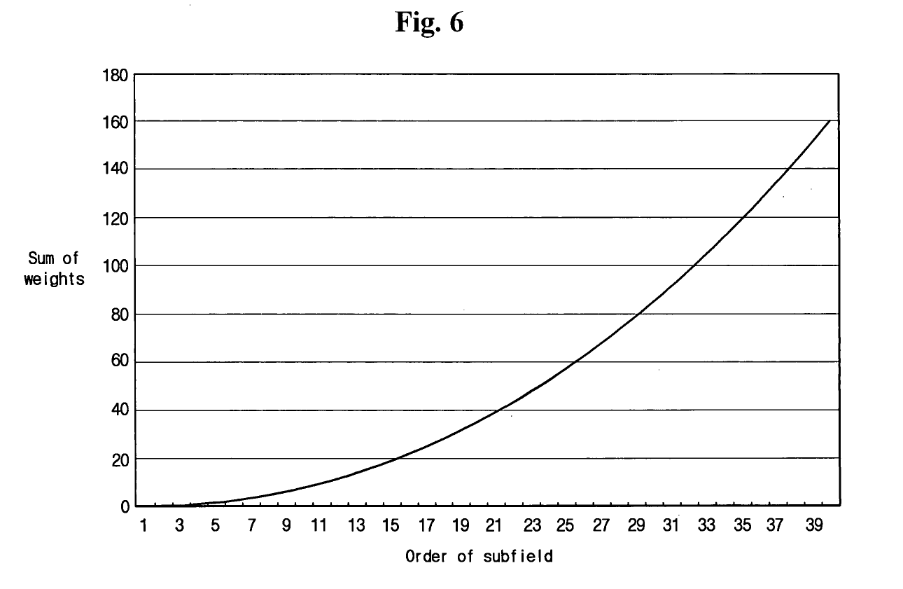

Next, an example of a subfield arrangement according to an embodiment of the present invention will be described with reference to FIGS. 5A, 5B and 6. FIGS. 5A and 5B show an example of the subfield arrangement according to an embodiment of the present invention. Numbers arranged in the vertical direction in a first column of FIG. 5A represent the order of row groups, and numbers arranged in the horizontal direction in first rows of FIGS. 5A and 5B represent the cycle of the sustain period.

As shown in FIGS. 5A and 5B, 480 row electrodes are divided into 16 blocks, and one field is composed of a total of 165 cycles of sustain discharge and is divided into 40 subfields. In the figures, number 2 represents time (in the unit of μs) during which the address period SW of the selective write process is performed for one row electrode, number 0.5 represents time (in the unit of μs) during which the address period HSE of a high-speed selective erase process is performed for one row electrode, and number 1 represents time (in the unit of μs) during which the address period NSE of a normal selective erase process is performed for one row electrode. In addition, in FIGS. 5A and 5B, it is assumed that the address period HSE of the high-speed selective erase process is performed for two row groups immediately after the sustain period.

In addition, weights of the subfields used in FIGS. 5A and 5B are gamma-corrected weights as shown in FIG. 6. More specifically, assuming that each of weights of all subfields is 1, linear gray scales are outputted by the sum of the weights of the subfields, however, assuming that the order of the subfields is an input gray scale, as shown in FIG. 6, and the sum of weights up to a corresponding subfield is an output gray scale. The output gray scale has a form of gamma correction for the input gray scale.

Referring to FIGS. 5A, 5B and 6, weights of first to third subfields are 0, weights of fourth to ninth subfields are 1, weights of tenth to 14^{th} subfields are 2, weights of 15^{th} to 18^{th} subfields are 3, weights of ₁₉^{th} to 22^{th} subfields are 4, weights of 23^{th} to 27^{th} subfields are 5, weights of 28^{th} to 31^{th} subfields are 6, weights of 32^{th} to 35^{th} subfields are 7, weights of 36^{th} to 39^{th} subfields are 8, and a weight of a 40^{th} subfield is 9. In addition, the erase period of the high-speed selective erase process HSE is performed after the 40^{th} subfield.

For example, for a 13^{th} sustain discharge cycle, a second sustain period of the 11^{th} subfield is performed for the first row group, the address period HSE and the sustain period of the 11^{th} subfield are performed for the second row group, a second sustain period of the 10^{th} subfield is performed for the third row group, the address period HSE and the sustain period of the 10^{th} subfield are performed for the 4^{th} row group, the address period NSE and the sustain period of the 9^{th}, 8^{th}, 7^{th}, 6^{th}, 5^{th}, 4^{th}, third and second subfields are performed for the 5^{th} to 12^{th} row groups, respectively, the address period SW and the sustain period of the first subfield are performed for the 13^{th} row group, and the 14^{th} to 16^{th} row groups are initialized in the reset period.

In FIGS. 5A and 5B, when the width of the scan pulse is set to 2 μS in the address period SW of the selective write process, the length of the address period SW for one row group becomes 60 μs. In addition, when the width of the scan pulse is set to 0.5 μs in the address period HSE of the high-speed selective erase process, the length of the address period HSE for one row group becomes 15 μs. In addition, when the width of the scan pulse is set to 1 μs in the address period NSE of the normal selective erase process, the length of the address period NSE for one row group becomes 30 μs. Time used for the address period or the erase period in each the sustain discharge cycle is shown in the last row of FIGS. 5A and 5B. In addition, when the length of the reset period is 350 μs and one cycle of the sustain discharge is 5 μs, time used for one field is 16.2 ms. That is, in the subfield arrangement according to the embodiment of the present invention, the use of 40 subfields for one field enables representation of 41 levels of gray scales. In this case, a 2×2 dithering technique may be applied to represent 164(=41×4) levels of gray scales, and, in addition to this, a 4-bit error diffusion technique may be further applied to represent 2624(=164×16) levels of gray scales.

As described above, according to the present invention, since the gray scales can be represented by the number of subfields successively lighted without using subfields having large weights, the problem of false contour can be overcome. In addition, since the addressing operation is performed for each row group after the sustain period, priming particles produced during the sustain period can be used for the address discharge, thus reducing the width of the scan pulse. In addition, since the width of the scan pulse can be further reduced by using the address period of the selective erase process, it is possible to achieve a high speed scan.

While this invention has been described in connection with certain exemplary embodiments, it is to be understood that the invention is not limited to the disclosed embodiments, but, on the contrary, is intended to cover various modifications and equivalent arrangements included within the spirit and scope of the appended claims and equivalents thereof.

1. A driving method for a plasma display panel having a plurality of discharge cells defined by a plurality of row electrodes and a plurality of column electrodes, the method comprising:
dividing a field into a plurality of subfields including a first group of subfields, with a first subfield positioned at the head in time of the plurality of subfields, and a second group of subfields;
grouping the plurality of row electrodes into a plurality of row groups; and
in at least one subfield:
performing an address period during which light-emitting cells of discharge cells of a first row group are selected;
performing a sustain period, during which light-emitting cells of discharge cells of the plurality of row groups are sustain-discharged;
performing an address period during which light-emitting cells of discharge cells of a second row group are selected; and
performing the sustain period,
wherein the light-emitting cells are selected by write-discharging non-light-emitting cells in a first address period, which is the address period for the first group of subfields, and the non-light-emitting cells are set by erase-discharging the light-emitting cells in a second address period, which is the address period for the second group of subfields.

2. The driving method of claim 1, wherein the second address period for at least one row group is performed in a first period, and the first period is between the sustain period immediately before the first address period for at least one third row group of the plurality of row groups and the sustain period immediately after the first address period for the third row group.

3. The driving method of claim 2, wherein the third row group is a row group other than that for which the address period of the first group of subfields is first performed in the plurality of row groups.

4. The driving method of claim 2, wherein the second address period is performed before the first address period is performed in the first period.

5. The driving method of claim 4, wherein if the second address periods for a plurality of row groups are performed in the first period, the second address period first performed is shorter than the second address period which is last performed.

6. The driving method of claim 1, wherein the first group of subfields includes only the first subfield.

7. The driving method of claim 6, further comprising:
performing a reset period during which discharge cells of the plurality of row groups are initialized to non-light-emitting cells before the first address period first performed in the first group of subfields.

8. The driving method of claim 7, wherein a weight of brightness of a k^{th} subfield is determined by the sum of the length of sustain periods existing between the first or second address period of the k^{th} subfield for the first group and the first or second address period of a (k+1)^{th} subfield for the first row group.

9. The driving method of claim 8, wherein when a discharge cell is set to non-light-emitting cells in the first or second address period of an n^{th} subfield after the discharge cell is set to light-emitting cells in the first address period of the first subfield, the discharge cell represents gray scales corresponding to the sum of weights of brightness of the first to n^{th} subfields.

10. The driving method of claim 8, wherein the length of the sustain periods is substantially constant in the plurality of subfields.

11. The driving method of claim 6, further comprising setting the light-emitting cells of the first row group to non-light-emitting cells after a last sustain period of a last subfield for the first row group is performed.

12. A driving method of dividing one field into a plurality of subfields and representing gray scales using the plurality of subfields in a plasma display panel including a plurality of row electrodes for performing a display operation, a plurality of column electrodes intersecting the plurality of row electrodes, and a plurality of discharge cells defined by the plurality of row electrodes and the plurality of column electrodes, the method comprising:
grouping the plurality of row electrodes into a plurality of row groups;
initializing all discharge cells in a first subfield positioned at a head in time of the plurality of subfields;
setting discharge cells to be light-emitting cells sequentially for each row group in the first subfield by a first type address discharge;
sustain-discharging the light-emitting cells between steps of setting light-emitting cells for two adjacent row groups in the first subfield;
setting light-emitting cells sequentially for each row group in a second subfield of the plurality of subfields by a second type address discharge; and
sustain-discharging the light-emitting cells between steps of setting light-emitting cells for two adjacent row groups in the second subfield,
wherein light-emitting cells of the second subfield for a second row group are set in a first period between two steps of sustain-discharging immediately before and after the step of setting the light-emitting cells of the first subfield for the first row group.

13. The driving method of claim 12, wherein discharge cells of non-light-emitting cell state are set to light-emitting cell state by the first type address discharge, and discharge cells of the light-emitting cell state are set to the non-light-emitting cell state by the second type address discharge.

14. The driving method of claim 13, wherein, after the light-emitting cells of the second subfield for the second row group are set in the first period, the light-emitting cell of the first subfield for the first row group are set.

15. The driving method of claim 14, further comprising:
setting light-emitting cells of the second subfield for a third row group in the first period, and
wherein, when the light-emitting cells of the second subfield for the second row group are set before the light-emitting cells of the second subfield for the third row group are set, a period assigned for the second type address discharge for the second row group is shorter than a period assigned for the second type address discharge for the third row group.

16. A driving method of a plasma display panel having a plurality of discharge cells defined by intersection of plurality of row electrodes and a plurality of column electrodes, the method comprising:
dividing a field into a plurality of subfields;
grouping the plurality of row electrodes into a plurality of row groups;
performing a first address period during which discharge cells of at least one of the plurality of row groups are selected to be light-emitting cells by write-discharging non-light emitting cells;
performing a first sustain period during which the light-emitting cells are sustain-discharged;
performing a second address period after the first address period, during which discharge cells of the at least one of the plurality of row groups are selected to be non-light emitting cells by erase-discharging the light-emitting cells.

17. The driving method of claim 16, wherein the second address period is performed after the first sustain period.

18. The driving method of claim 16, further comprising:
performing a second sustain period after the second address period;
performing a third address period before the second sustain period, during which discharge cells of other of the at least one of the plurality of row groups are selected to be light-emitting cells by write-discharging non-light-emitting cells; and
performing a fourth address period after the third address period, during which discharge cells of the other of the at least one of the plurality of row groups are selected to be non-light-emitting cells by erase-discharging the, light-emitting cells.

19. The driving method of claim 18, further comprising performing a third sustain period, and wherein the fourth address period is performed between the second sustain period and the third sustain period.

20. The driving method of claim 16, wherein the second address period is shorter than the first address period.
